(19) United States
(12) Patent Application Publication
(10) Pub. No.: US 2020/0254951 A1
(43) Pub. Date: Aug. 13, 2020

(54) AUTOMATIC DOOR ALERT AND NOTIFICATION SYSTEM

(71) Applicant: GM Global Technology Operations LLC, Detroit, MI (US)

(72) Inventor: Venkatesh Narasimhan, Bangalore (IN)

(21) Appl. No.: 16/273,803

(22) Filed: Feb. 12, 2019

(51) Int. Cl. B60R 21/015; B60Q 1/32

(52) U.S. Cl. CPC B60R 21/01542; B60R 2021/0102; B60Q 1/323

(57) ABSTRACT

A notification system for indicating a side door of a vehicle is about to opened is disclosed. The notification system includes a control module in electronic communication with the illumination device. The control module executes instructions to receive as input a movement signal indicating the vehicle is either stationary or is traveling at an exit speed. The control module also receives as input an actuation signal indicating the passenger is actuating a door input. In response to receiving the movement signal and the actuation signal, the control module determines the passenger is about to open the side door. The control module then activates the illumination device. The illumination device generates a visual indicator when activated to provide a notification to individuals located outside of the vehicle that the side door of the vehicle is about to be opened.

### INTRODUCTION

The present disclosure relates to a vehicle having a notification system. More particularly, the present disclosure relates to a notification system that provides an indication to individuals located outside of the vehicle when a side door of the vehicle is about to be opened by a passenger.

A vehicle, such as an automobile, typically includes a driver's side door and a passenger's side door. Many automobiles also include rear passenger side doors as well. A passenger may open one of the side doors once the vehicle is parked or has stopped moving and is located along the side of a road. The passenger may then exit the vehicle. For example, a passenger may open a side door and then exit when the vehicle is parallel parked along the side of a road.

A passenger creates an obstruction along the roadway when he or she swings open one of the side doors of the vehicle. Accordingly, passengers are supposed to open the side doors of a vehicle without substantially interfering with the movement of traffic. In addition to traffic, the side doors of the vehicle also need to avoid interfering with the movement of bicyclists, pedestrians, or any other individual traveling along the road. Passengers need to be especially attentive when opening the side doors of a vehicle along the side of the road in more urban areas due to increased traffic as well as the number of pedestrians and bicyclists.

Thus, while current vehicles achieve their intended purpose, there is a need for a new and improved system and method for providing an additional notification to vehicles, pedestrians, and bicyclists when a passenger opens a side door of a vehicle along the side of the road.

### SUMMARY

According to several aspects, a notification system having an illumination device for indicating a side door of a vehicle is about to be opened is disclosed. The notification system includes a control module in electronic communication with the illumination device. The control module executes instructions to receive as input a movement signal indicating the vehicle is either stationary or is traveling at an exit speed. The control module executes instructions to receive as input an actuation signal indicating a passenger is actuating a door input. In response to receiving the movement signal and the actuation signal, the control module executes instructions to determine the passenger is about to open the side door. The control module also executes instructions to activate the illumination device, where the illumination device generates a visual indicator when activated to provide a notification to individuals located outside of the vehicle that the side door of the vehicle is about to be opened.

In another aspect, the illumination device is configured to generate at least one of text, graphics, and images.

In still another aspect, the illumination device is a light emitting diode (LED) display.

In yet another aspect, the illumination device is a rear exterior light of the vehicle.

In another aspect, the rear exterior light is at least one of a tail light, a center high mount stop lamp, or both the tail light and the center high mount stop lamp.

In still another aspect, the notification system further comprises an audio device in electronic communication with the control module, where the audio device provides an audio signal indicating the side door of the vehicle is about to be opened.

In yet another aspect, the audio signal is a human voice.

In another aspect, the movement signal indicates a current gear position of a transmission of the vehicle.

In still another aspect, the control module executes instructions to determine the current gear position of the transmission is park based on the movement signal. In response to determining the current gear position is park, the control module determines the vehicle is stationary.

In yet another aspect, the control module executes instructions to determine the current gear position of the transmission is neutral based on the movement signal. In response to determining the current gear position is neutral, the control module executes instructions to determine the vehicle is traveling at the exit speed or is stationary.

In another aspect, the movement signal is a vehicle speed signal.

In still another aspect, the actuation signal indicates the passenger is either manually or electronically actuating a door handle to open the side door of the vehicle.

In yet another aspect, the actuation signal indicates a hand is either directly adjacent to or is in contact with a door handle of the side door.

In another aspect, the actuation signal indicates a door lock button of the side door is being actuated from a locked position and into an unlocked position.

In still another aspect, the actuation signal indicates one or more buttons of a master switch are being actuated from a locked position and into an unlocked position.

In yet another aspect, the control module executes instructions to receive signals indicating a distance of one or more objects approaching a rear end of the vehicle. The control module further executes instructions to determine a presence of one or more moving objects approaching the rear end of the vehicle based on the signals. In response to determining the presence of the one or more moving objects approaching the rear end of the vehicle, the control module executes instructions to activate an interior indicator, where the interior indicator creates a visual signal when activated.

In another aspect, the interior indicator is located along an interior surface of the side door.

In still another aspect, a method for providing an indication that a side door of a vehicle is about to be opened is disclosed. The method comprises receiving, by a control module, a movement signal indicating the vehicle is either stationary or is traveling at an exit speed. The method also includes receiving, by the control module, an actuation signal indicating a passenger is actuating a door input. In response to receiving the movement signal and the actuation signal, the method includes determining the passenger is about to open the side door. The method also includes activating an illumination device. The illumination device is in electronic communication with the control module. Finally, the method includes generating, by the illumination device, a visual indicator that provides a notification to individuals located outside of the vehicle the side door of the vehicle is about to be opened.

In an aspect, the method further comprises providing an audio signal by an audio device in electronic communication with the control module. The audio signal indicates the side door of the vehicle is about to be opened.

In another aspect, the method further comprises receiving, by the control module, signals indicating a distance of one or more objects approaching a rear end of the vehicle. The method also includes determining, by the control module, a presence of one or more moving objects approaching the rear end of the vehicle based on the signals. In response to determining the presence of the one or more moving objects approaching the rear end of the vehicle, the method includes activating an interior indicator. The interior indicator creates a visual signal that is visible within the vehicle when activated.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of the disclosed vehicle, where the vehicle includes one or more side doors according to an exemplary embodiment;

FIG. 2 is a rear view of the vehicle shown in FIG. 1 according to an exemplary embodiment;

FIG. 3 is a schematic diagram of a notification system for the vehicle shown in FIGS. 1 and 2, where the notification system provides an alert indicating one of the side doors seen in FIG. 1 is about to be opened according to an exemplary embodiment;

FIG. 4 is an illustration of a handle located along an interior surface a side door of the vehicle shown in FIG. 1 according to an exemplary embodiment;

FIG. 5 is an illustration of a master switch according to an exemplary embodiment; and

FIG. 6 is a process flow diagram illustrating a method for providing an alert indicating one of the side doors of the vehicle is about to be opened according to an exemplary embodiment.

### DETAILED DESCRIPTION

The following description is merely exemplary in nature and is not intended to limit the present disclosure, application, or uses.

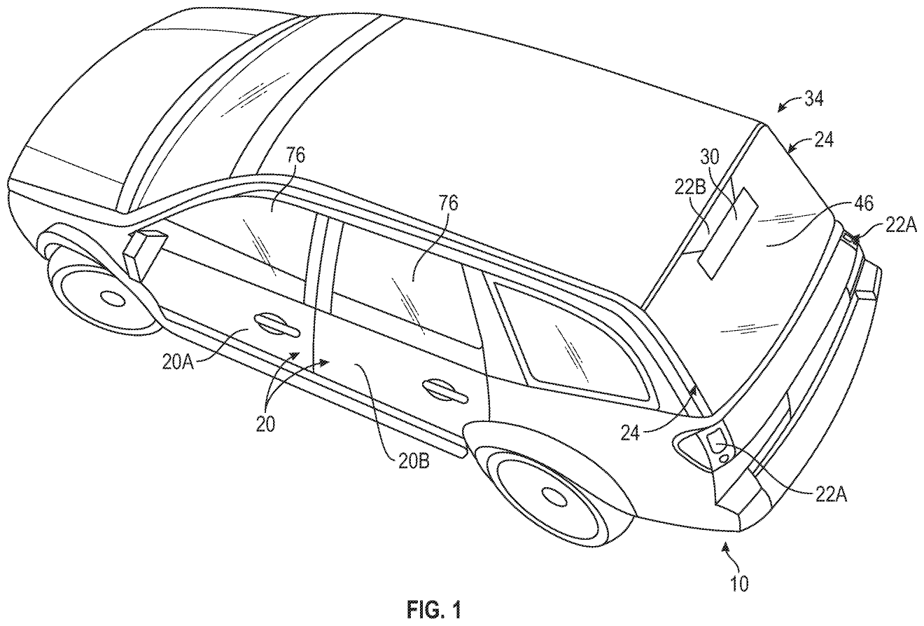

Referring to FIG. 1, a vehicle 10 having one or more passenger or side doors 20 is shown. In an embodiment, the vehicle 10 includes a driver's side door 20A, a passenger's side door (not visible in FIG. 1), and two rear passenger side doors 20B (only one of the passenger side doors 20B is visible in FIG. 1). Although the vehicle 10 shown in FIG. 1 includes four side doors 20, it is to be appreciated that the vehicle 10 may include any number of side doors 20. For example, in another embodiment the vehicle 10 may only include the driver's side door 20A and the passenger's side door, and no rear passenger side doors. In an embodiment, the vehicle 10 is an automobile such as, for example, a sport utility vehicle, coupe, sedan, or van.

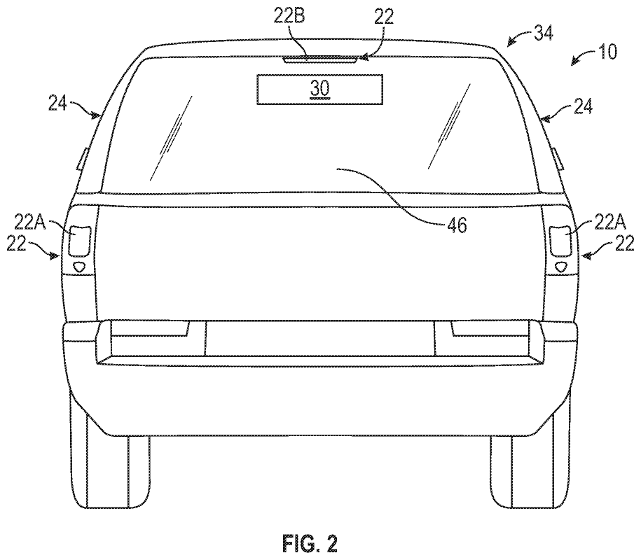

FIG. 2 is a rear view of the vehicle 10 shown in FIG. 1. Referring to both FIGS. 1 and 2, the vehicle 10 includes rear exterior lights 22. Specifically, the rear exterior lights 22 include tail lights 22A and a center high mount stop lamp 22B. The tail lights 22A are disposed on opposite sides 24 of the vehicle 10 and include the brake and the turn signal lamps. In an embodiment, the vehicle 10 also includes a display lamp 30 located below the center high mount stop lamp 22B.

Although FIG. 2 illustrates the display lamp 30 located directly below the center high mount stop lamp 22B, it is to be appreciated that the display lamp 30 is not limited to the specific position as illustrated. Instead, the display lamp 30 may be positioned along any location along a rear end 34 of the vehicle 10 as long as the display lamp 30 is visible to individuals located outside and behind the vehicle 10. For example, in another embodiment, the display lamp 30 may be located directly underneath a rear glass 46 of the vehicle 10. In one embodiment, the exterior lights 22 are light emitting diode (LED) lights, however it is to be appreciated that the disclosure is not limited to a specific type of light.

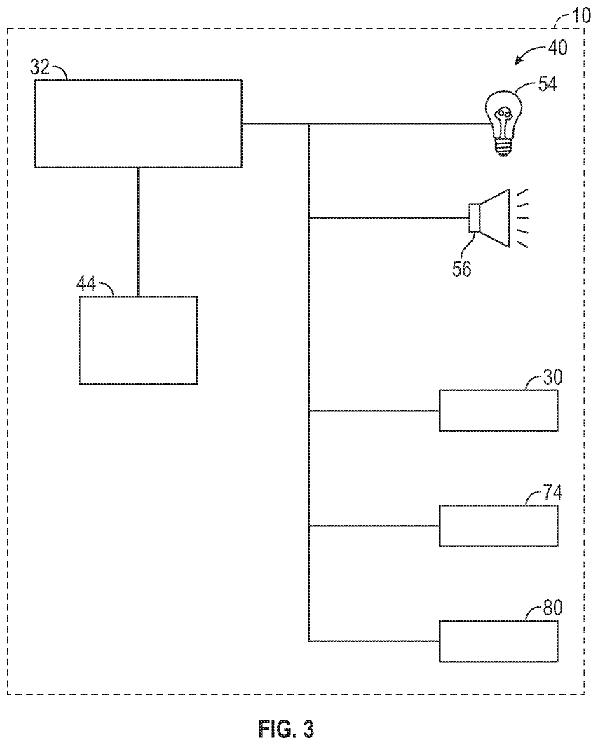

FIG. 3 is an exemplary schematic diagram illustrating a notification system 40 of the vehicle 10. The notification system 40 includes the exterior lights 22, the display lamp 30, a control module 32, and an audio device 56. The control module 32 is in electronic communication with the exterior lights 22, the display lamp 30, one or more control modules 44 located within the vehicle 10, and the audio device 56. In one non-limiting embodiment, the control modules 44 may include a body control module, a door control module, or a transmission control module. However, it is to be appreciated that the disclosure is not limited to any specific type of control module. Referring to FIGS. 1, 2, and 3, the notification system 40 is configured to provide an alert or notification to individuals located outside of the vehicle 10 indicating one of the side doors 20 of the vehicle 10 is about to be opened. As explained below, a visual notification is generated by one or more illumination devices 54 (seen in FIG. 3). In some embodiments, an audio notification is also generated by the audio device 56 as well (FIG. 3). Referring specifically to FIG. 3, the control module 32 is in electronic communication with the illumination device 54 and the audio device 56.

The control modules 32 and 44 are a non-generalized, electronic control device having one or more preprogrammed digital computers or processors, memory or non-transitory computer readable medium coupled to one or more processors used to store data such as control logic, instructions, image data, lookup tables, etc., and a plurality of input/output peripherals or ports. The processor of the control module is configured to execute the control logic or instructions.

The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted. One or more data structures may also reside in memory, and may be used by the processor, operating system, or application to store or manipulate data.

Referring to FIGS. 2 and 3, the illumination device 54 is configured to generate a visual notification when activated. The visual notification indicates the side door 20 of the vehicle 10 is about to be opened. In one embodiment, the illumination device 54 is the display lamp 30. The control module 32 activates the display lamp 30 by instructing the display lamp 30 to illuminate (i.e., turn on and produce visible light). The display lamp 30 may be any device configured to generate text, graphics, or images that are visible to individuals located outside of the vehicle 10. More specifically, the text, graphic, or images generated by the display lamp 30 are visible to individuals located up to about fifteen to twenty meters from the rear end 34 of the vehicle 10. More specifically, the visual notification generated by the display lamp 30 notifies individuals such as drivers, pedestrians, and bicyclists of an imminent obstruction that may be created as one of the side doors 20 of the vehicle 10 are opened. Accordingly, the driver, pedestrian, or bicyclist may decide to change his or her direction of travel in order to avoid the obstruction. Alternatively, the pedestrian or bicyclist may also stop moving in order to avoid the obstruction that is created as the side door 20 of the vehicle 10 is opened.

In one specific embodiment, the display lamp 30 is an LED display configured to generate text indicating the side door 20 of the vehicle 10 is about to opened. For example, the text may read “Side Door Opening!”. In another embodiment, the display lamp 30 may generate an image of a red octagon or stop sign. It is to be appreciated that the display lamp 30 may generate any type of text, graphic, or image that provide a notification to individuals located outside of the vehicle 10 that a passenger is about to open one of the side doors 20. However, in an alternative embodiment the display lamp 30 may be omitted. Instead, the rear exterior lights 22 are the illumination device 54. Specifically, in response to determining a passenger is about to open one of the side doors 20 of the vehicle 10, the control module 32 instructs the tail lights 22A, the center high mount stop lamp 22B, or both the tail lights 22A and the center high mount stop lamp 22B to flash, blink, or otherwise create an indication of an imminent obstruction.

The audio device 56 is any device configured to generate a sound signal that is audible to individuals located up to about fifteen to twenty meters from the rear end 34 of the vehicle 10. More specifically, the audio notification generated by the audio device 56 notifies individuals such as pedestrians and bicyclists of an imminent obstruction that may be created as one of the side doors 20 of the vehicle 10 are opened. The audio device 56 may be, for example, a speaker. In an embodiment, the audio notification is a human's voice that states the side door 20 is about to open. For example, the human voice may say “The side door is opening” to alert individuals that the side door 20 of the vehicle 10 is about to open. In another embodiment, the audio notification may be a beeping sound, a buzzer, or any other tone that notifies individuals of an impending obstruction.

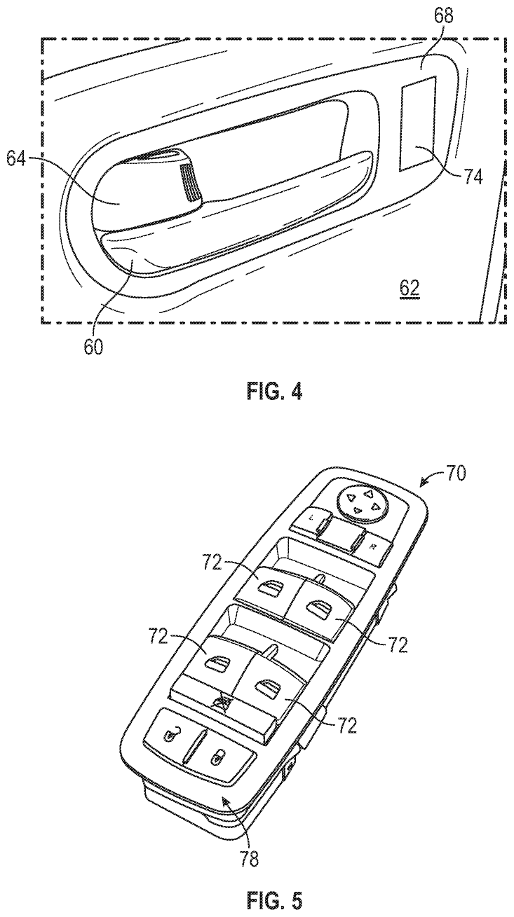

FIG. 4 is an exemplary illustration of a door handle 60 located along an interior surface 62 of one of the side doors 20 (seen in FIG. 1). In the embodiment as shown, the door handle 60 is a mechanical release lever that is manually actuated by a passenger. However, it is to be appreciated that an electronic door latch may be used instead. A door lock button 64 is also located along the interior surface 62 of the side door 20 as well. In an embodiment, the door lock button 64 is part of the same trim piece 68 as the door handle 60. However, it is to be appreciated that the door lock button 64 is not limited to the specific location as shown in FIG. 4.

In one non-limiting embodiment, an interior indicator 74 is also located along an interior surface 62 of the side door 20. Specifically, in the exemplary embodiment as shown the interior indicator 74 is also located on the trim piece 68. However, it is to be appreciated that the interior indicator 74 may be located anywhere along the interior surface 62 of the side door 20 that is readily visible to a passenger. The interior indicator 74 is any device configured to generate a notification to the passengers located within the vehicle such as, for example, an LED light. In some embodiments, the LED light may generate colored light (e.g., red light) to attract the attention of the passengers. In another embodiment, the interior indicator 74 may flash or blink instead to attract attention. As explained below, the interior indicator 74 notifies passengers of vehicle 10 when objects are approaching the rear end 34 of the vehicle 10 (FIGS. 1 and 2) when a passenger is about to open the side door 20 of the vehicle 10.

FIG. 5 is an illustration of an exemplary master switch 70 that may be provided along the interior of the driver's side door 20A (FIG. 1). Alternatively, in another embodiment, the master switch 70 may be located between a driver's side and a passenger's side seat. The master switch 70 may include one or more buttons 72 for controlling all of the side windows 76 (FIG. 1) as well as one or more buttons 78 for locking and unlocking all of the side doors 20 of the vehicle 10.

Referring to FIGS. 1, 3, and 4, the notification system 40 is configured to generate one or more notifications that one of the side doors 20 are about to open. The control module 32 first determines that the vehicle 10 has either stopped or, alternatively, is travelling at an exit speed. The exit speed indicates that the vehicle is 10 is decelerating into a stop, or rolling slowly into a stationary position. In an embodiment, the exit speed is any speed equal to or less than about twenty kilometers per hour (kmph).

The control module 32 receives as input a movement signal indicating the vehicle 10 is either stationary or is traveling at the exit speed. The movement signal is generated by one of the control modules 44 or, alternatively, by one or more sensors (not shown) located in the vehicle 10. In one example, the movement signal is received from a transmission control module and indicates the current gear position of a transmission (not shown) of the vehicle 10. The control module 32 determines the vehicle 10 has stopped and is stationary in response to determining the gear position of the transmission is park (P). Furthermore, the control module 32 determines the vehicle 10 is stationary or is traveling at the exit speed in response to determining the gear position of the transmission is neutral (N). Alternatively, the control module 32 receives a vehicle speed signal which represents a speed of the vehicle 10. Thus, the control module 32 may determine that the vehicle 10 is stationary or is traveling at the exit speed based on the vehicle speed signal.

The control module 32 further receives as input an actuation signal indicating the passenger is actuating a door input. The door input may be the door handle 60, the door lock button 64 (FIG. 4), or the buttons 78 of the master switch 70 (FIG. 5) of the side door 20 of the vehicle 10. In an embodiment, the actuation signal is generated by a door control module and indicates that the passenger is either manually or electronically actuating the door handle 60 to open the side door 20 of the vehicle 10. Alternatively, in another approach, the actuation signal indicates a hand is either directly adjacent to or is in contact with the door handle 60. For example, an infrared sensor may be used to detect the presence of the passenger's hand near the door handle 60. In yet another embodiment, the actuation signal indicates the door lock button 64 is being actuated from a locked position and into an unlocked position. In still another embodiment, the actuation signal indicates that the buttons 78 of the master switch 70 are being actuated from the lock position and into the unlocked position.

In response to receiving the movement signal and the actuation signal, the control module 32 determines a passenger is about to open a side door 20 of the vehicle 10. In other words, the notification system 40 is triggered once the control module 32 determines that the passenger is about to open the side door 20. The control module 32 then activates the illumination device 54. As mentioned above, the illumination device 54 may be the display lamp 30, and the visual notification may be a lighted message that notifies individuals located behind the vehicle 10 that a side door 20 is about to open. Furthermore, in an embodiment the control module 32 also activates the audio device 56. When activated, the audio device 56 generates an audio signal indicating the side door 20 is about to be opened.

Referring specifically to FIGS. 1, 3, and 4, in one embodiment the notification system 40 also provides an alert or notification to the passengers in the vehicle 10. The notification indicates there are vehicles, pedestrians, bicyclists, or any other object that may impact the vehicle 10 approaching the rear end 34 of the vehicle 10. Specifically, the control module 32 is in electrical communication with the interior indicator 74 and one or more detection devices 80. The detection device 80 may be any device configured to detect the presence and movement of vehicles, pedestrians, bicyclists, or other objects behind the vehicle 10. For example, the detection device 80 may include park assist sensors or outside rear-view mirror sensors.

The detection device 80 generates signals indicating the distance of one or more moving objects approaching the rear end 34 of the vehicle 10 (FIG. 1). The control module 32 receives as input the signals from the detection device 80 and determines the presence of one or more moving objects approaching the rear end 34 of the vehicle 10. In response to determining the presence of one or more moving approaching the rear end 34 of the vehicle 10, the control module 32 activates the interior indicator 74. When activated, the interior indicator 74 creates a visual signal that is visible within the vehicle. The visual signal is configured to attract the attention of the passenger and alerts him or her of moving objects behind the vehicle 10. In some embodiments, the interior indicator 74 may flash or blink to attract the attention of the passenger. It is to be appreciated that the control module 32 first determines that the passenger is about to open the side door 20 of the vehicle 10 before determining the presence of one or more moving objects located behind the vehicle 10 based on the signals from the detection device 80. In other words, the control module 32 does not activate the interior indicator 74 unless the side door 20 is about to be opened.

It is to be appreciated that the notification system 40 operates when an engine or other prime mover of the vehicle 10 is on, as well as during an accessory mode of the vehicle 10. In other words, the notification system 40 may operate when the engine is turned off, but when electrical power is still provided by the batter of the vehicle 10.

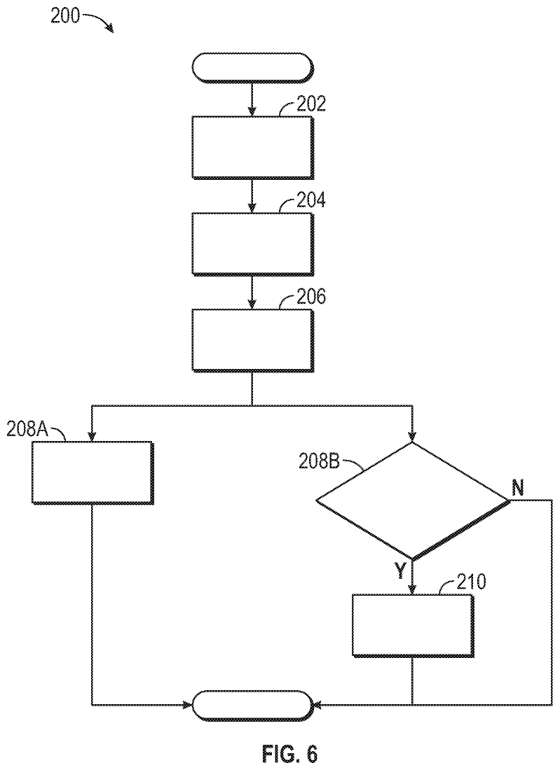

FIG. 6 is an exemplary process flow diagram illustrating an exemplary method 200 for indicating the side door 20 of the vehicle 10 is about to be opened. Referring generally to FIGS. 1, 3, and 6, the method 200 may begin at block 202. In block 202, the control module 32 receives as input the movement signal. As mentioned above, the movement signal indicates the vehicle 10 is either stationary or is traveling at the exit speed. The method may then proceed to block 204.

In block 204, the control module 32 receives the actuation signal indicating the passenger is actuating a door input. The door input may be, for example, the door handle 60 (seen in FIG. 4), the door lock button 64 (seen in FIG. 4), or the buttons 78 of the master switch 70 (seen in FIG. 5) that are configured to lock and unlock the side doors 20 of the vehicle 10. The method 200 may then proceed to block 206.

In block 206, the control module 32 determines that the passenger is about to open the side door 20. The method 200 may then proceed to both blocks 208A and 208B. It is to be appreciated that both blocks 208A and 208B are performed at about the same time.

In block 208A, the control module 32 activates the illumination device 54. As mentioned above, the illumination device 54 generates a visual notification for informing individuals such as pedestrians and bicyclists of an imminent obstruction that may be created as one of the side doors 20 of the vehicle 10 are opened. In an embodiment, the control module 32 also activates the audio device 56 as well.

In block 2086, the control module 32 receives signals from the detection device 80 indicating the presence of one or more objects located behind the rear end 34 of the vehicle 10. The method 200 may then proceed to block 210.

In block 210, the control module 32 activates the interior indicator 74 (seen in FIG. 4). The passenger sees the interior indicator 74 flashing, blinking, or otherwise creating an alert as he or she opens the side door of the vehicle 10. The method 200 may then terminate.

Technical effects and benefits of the present disclosure provide an approach for notifying individuals located behind a vehicle of an imminent obstruction that is created when a passenger swings a side door of a vehicle open. Accordingly, vehicles, pedestrians, bicyclists, and other individuals may modify their direction of travel to avoid the obstruction created when the side door is opened. In an embodiment, the disclosure also provides an indication to the passengers of the vehicle informing them of moving vehicles, pedestrians, bicyclists, or other objects that are located behind the vehicle. Therefore, the passengers are aware of moving vehicles, pedestrians, or bicyclists that may be approaching the vehicle before he or she swings the side door open to exit the vehicle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A notification system having an illumination device for indicating a side door of a vehicle is about to be opened, the notification system comprising:
a control module in electronic communication with the illumination device, wherein the control module executes instructions to:
receive as input a movement signal indicating the vehicle is either stationary or is traveling at an exit speed;
receive as input an actuation signal indicating a passenger is actuating a door input;
in response to receiving the movement signal and the actuation signal, determine the passenger is about to open the side door; and
activate the illumination device, wherein the illumination device generates a visual indicator when activated to provide a notification to individuals located outside of the vehicle that the side door of the vehicle is about to be opened.

2. The notification system of claim 1, wherein the illumination device is configured to generate at least one of text, graphics, and images.

3. The notification system of claim 1, wherein the illumination device is a light emitting diode (LED) display.

4. The notification system of claim 1, wherein the illumination device is a rear exterior light of the vehicle.

5. The notification system of claim 4, wherein the rear exterior light is at least one tail light, a center high mount stop lamp, or both the tail light and the center high mount stop lamp.

6. The notification system of claim 1, further comprising an audio device in electronic communication with the control module, wherein the audio device provides an audio signal indicating the side door of the vehicle is about to be opened.

7. The notification system of claim 6, wherein the audio signal is a human voice.

8. The notification system of claim 1, wherein the movement signal indicates a current gear position of a transmission of the vehicle.

9. The notification system of claim 8, wherein the control module executes instructions to:
determine the current gear position of the transmission is park based on the movement signal; and
in response to determining the current gear position is park, determine the vehicle is stationary.

10. The notification system of claim 8, wherein the control module executes instructions to:
determine the current gear position of the transmission is neutral based on the movement signal; and
in response to determining the current gear position is neutral, determine the vehicle is traveling at the exit speed or is stationary.

11. The notification system of claim 1, wherein the movement signal is a vehicle speed signal.

12. The notification system of claim 1, wherein the actuation signal indicates the passenger is either manually or electronically actuating a door handle to open the side door of the vehicle.

13. The notification system of claim 1, wherein the actuation signal indicates a hand is either directly adjacent to or is in contact with a door handle of the side door.

14. The notification system of claim 1, wherein the actuation signal indicates a door lock button of the side door is being actuated from a locked position and into an unlocked position.

15. The notification system of claim 1, wherein the actuation signal indicates one or more buttons of a master switch are being actuated from a locked position and into an unlocked position.

16. The notification system of claim 1, wherein the control module executes instructions to:
receive signals indicating a distance of one or more objects approaching a rear end of the vehicle;
determine a presence of one or more moving objects approaching the rear end of the vehicle based on the signals; and
in response to determining the presence of the one or more moving objects approaching the rear end of the vehicle, activate an interior indicator, wherein the interior indicator creates a visual signal when activated.

17. The notification system of claim 16, wherein the interior indicator is located along an interior surface of the side door.

18. A method for providing an indication that a side door of a vehicle is about to be opened, the method comprising:
receiving, by a control module, a movement signal indicating the vehicle is either stationary or is traveling at an exit speed;
receiving, by the control module, an actuation signal indicating a passenger is actuating a door input;
in response to receiving the movement signal and the actuation signal, determining the passenger is about to open the side door;
activating an illumination device, wherein the illumination device is in electronic communication with the control module; and
generating, by the illumination device, a visual indicator that provides a notification to individuals located outside of the vehicle the side door of the vehicle is about to be opened.

19. The method of claim 18, further comprising:
providing an audio signal by an audio device in electronic communication with the control module, wherein audio signal indicates the side door of the vehicle is about to be opened.

20. The method of claim 18, further comprising:
receiving, by the control module, signals indicating a distance of one or more objects approaching a rear end of the vehicle;
determining, by the control module, a presence of one or more moving objects approaching the rear end of the vehicle based on the signals; and
in response to determining the presence of the one or more moving objects approaching the rear end of the vehicle, activating an interior indicator, wherein the interior indicator creates a visual signal that is visible within the vehicle when activated.
